(19) United States
(12) Patent Application Publication
(10) Pub. No.: US 2024/0067090 A1
(43) Pub. Date: Feb. 29, 2024

(54) METHOD FOR AUTOMATED ADAPTING OF AN ADJUSTMENT OF A MIRROR SURFACE OF AT LEAST ONE OUTSIDE MIRROR OF A MOTOR VEHICLE AND MOTOR VEHICLE HAVING AN OUTSIDE MIRROR

(71) Applicant: CARIAD SE, Wolfsburg (DE)

(72) Inventor: Tobias SCHLEICHER, Wettstetten (DE)

(21) Appl. No.: 18/457,231

(22) Filed: Aug. 28, 2023

(30) Foreign Application Priority Data
Aug. 31, 2022 (DE) 102022122033.8

(51) Int. Cl. B60R 1/062; B60R 1/12; B60R 1/29; G06V 40/19; H04N 9/31

(52) U.S. Cl. CPC B60R 1/062; B60R 1/12; B60R 1/29; G06V 40/19; H04N 9/3141; H04N 9/3194; B60R 2001/1223

(57) ABSTRACT

A method is provided for adapting an adjustment of a mirror surface of an outside mirror of a motor vehicle to an eye point of a driver of the motor vehicle, as well as a motor vehicle having the outside mirror, wherein the outside mirror comprises an actuator, wherein the mirror surface is mounted in a housing of the outside mirror able to swivel by adjusting a respective actuator position on the actuator. In the method, an actuator position is coordinated with a projection point in an interior of the motor vehicle, the projection point being described by spatial coordinates in the interior of the motor vehicle on which a known light source is projected from outside the motor vehicle and directed at the mirror surface of the outside mirror. The eye point of the driver is determined, coordinating the eye point with spatial coordinates in the interior of the motor vehicle. The adjustment of the mirror surface is adapted to the eye point by adjusting at the actuator that actuator position which is coordinated with the projection point whose spatial coordinates correspond to the spatial coordinates of the eye point.

### BACKGROUND

### Technical Field

The present disclosure relates to a method for adapting an adjustment of a mirror surface of at least one outside mirror of a motor vehicle to a current eye point of a driver of the motor vehicle. The disclosure further relates to a motor vehicle having an outside mirror.

### Description of the Related Art

The outside mirrors of a motor vehicle, as is known, serve for providing the driver of the motor vehicle with information about rear areas of the motor vehicle, without having to significantly change his position in the motor vehicle interior. For this, it is necessary that the mirror surfaces of the outside mirror be oriented such that they reflect or project the respective rear areas of the motor vehicle in a visual range or on an eye point of the driver. Manual methods for adjusting such a mirror surface are sufficiently known. In these methods, the driver of the motor vehicle must select one of the outside mirrors and after making the selection he can swivel the mirror surface into the desired position either by mechanical actuators or by electrical actuators.

Furthermore, methods are known in which the eye point of the driver is detected, for example by an interior camera or also approximately in terms of a known seat position of the driver, and the mirror surface can then be pointed at the eye point so determined.

From the document US 2019/0375332 A1 it is known how to read out a desired mirror adjustment from a look-up table, wherein definite eye positions are coordinated with desired adjustments for the mirror in the look-up table. This has the drawback that it is only possible to read out desired mirror adjustments for those eye positions which are present in the look-up table. No reliable mirror adjustment can be done for any other eye positions.

A method is likewise known from the document DE 19852873 A1 which adapts a viewing direction of an outside mirror to an ascertained eye position of a driver. It is proposed here that the driver or an attendant will specify desired target values for a particular eye position, an evaluation and control device will set these target values, and place them in a memory after receiving a confirmation signal triggered by the attendant. The specifying of the desired target values is time consuming and complicated. This increases the risk of the attendant neglecting to make the correct adjustment of the outside mirror.

### BRIEF SUMMARY

Embodiments of the present disclosure simplify the automated adapting of an adjustment of a mirror surface of an outside mirror of a motor vehicle as compared to the known methods and thus make a contribution to traffic safety.

The present disclosure provides a method for the automated adapting of an adjustment of a mirror surface of at least one outside mirror of a motor vehicle to a current eye point of a driver of the motor vehicle. The outside mirror comprises at least one actuator, the mirror surface being mounted in a housing of the outside mirror and able to swivel by adjusting a respective actuator position on the actuator. In some embodiments, the mirror surface may be mounted so as to swivel about a vertical axis (z-axis) and about a transverse axis (y-axis) of the motor vehicle or to tumble in the housing.

In a first step or calibration step, a respective actuator position of the actuator is coordinated with a respective projection point in an interior of the motor vehicle. The projection point is described by those spatial coordinates in the interior of the motor vehicle on which a known light source is projected from outside the motor vehicle and directed at the mirror surface of the outside mirror. In other words, in the calibration step described here, a light source is arranged outside the motor vehicle such that the light emitted by the light source falls on the mirror surface. The light source may be, for example, a laser pointer or a headlamp. The light source is known, that is, it is positioned at a known and predetermined position in regard to the mirror surface. The known position may be located behind the vehicle and/or at the side of the vehicle. The light source so positioned is projected or reflected or deflected by the mirror surface into the interior of the motor vehicle. Depending on the adjusted actuator position of the actuator, the projection point will be located in a different spot within the interior of the motor vehicle. According to the method described herein, the respective actuator position is placed in relation to the respective projection point. Thus, the calibration consists in coordinating each projection point in the motor vehicle interior with exactly one actuator position. In other words, the spatial coordinates of the projection point are coordinated with exactly one actuator position.

In a further step, the current eye point of the driver of the motor vehicle is determined, coordinating the eye point with spatial coordinates in the interior of the motor vehicle.

Finally, the adjustment of the mirror surface is adapted to the eye point so determined by adjusting at the actuator that actuator position which is coordinated with the projection point whose spatial coordinates correspond to the spatial coordinates of the eye point. In other words, the mirror surface is swiveled such that the light source directed from outside the motor vehicle onto the mirror surface of the outside mirror is projected onto the spatial coordinates of the eye point.

The method described herein furnishes the benefit that the coordination of the eye point and the mirror adjustment is not limited by a prior selection, for example, by selection of permanently specified values of a look-up table. The time consuming specification of desired target values may also be omitted.

Some embodiments of the present disclosure may also yield further benefits.

One embodiment calls for the coordination of the current actuator position of the actuator and the current projection point to be done by moving the actuator from a first known actuator position to at least one further known actuator position, wherein an image detection device in the interior of the motor vehicle registers the respective current spatial coordinates of the projection point migrating with the movement of the actuator from the first to the second actuator position in the interior, and the respective current spatial coordinates are permanently assigned to the respective current actuator position. The first known actuator position may be a first extreme position of a servo motor of the actuator. The at least one further known actuator position may be a second extreme position situated opposite the first extreme position. In other words, therefore, the mirror surface can be swiveled such that its entire visual field or projection field is traveled in the motor vehicle interior. The swiveling may be continuous. In the course of the swiveling, the projection point migrates along the motor vehicle interior along the entire geometrically reachable projection region of the mirror surface. This is accompanied by the registering of the migrating projection point by the image detection device. The image detection device may be an interior camera. In some embodiments, the image detection device may register each time the current spatial coordinates of the migrating projection point. The respective current spatial coordinates may be permanently assigned to the respective current actuator position, and the respective current actuator position may be described by a corresponding control signal.

This yields the benefit that precise knowledge can be obtained as to which actuator position projects the light source situated outside the motor vehicle onto which point of the interior of the motor vehicle.

Advantageously, a respective actuator position may be described by the time elapsed since leaving the first known and/or since leaving the further known actuator position. For example, the speed with which the mirror surface is swiveled on account of the changing actuator position may be known. For example, a projection point detected by the image detection device can be placed in a relation with the time elapsed since leaving the first known actuator position. In other words, it is known how long it must take for the projection point to be situated at a predetermined position in the vehicle interior.

A further embodiment calls for the spatial coordinates of the projection point to be determined by ascertaining the relative spatial position of the projection point in regard to a spatially unchanging component having known spatial coordinates in the interior of the motor vehicle, especially in regard to a handle (and/or the B-column) of the motor vehicle.

Alternatively or additionally, the spatial coordinates of the projection point may be determined by ascertaining the relative spatial position of the projection point in regard to a driver seat of the motor vehicle, such as in regard to a headrest of the driver seat. According to the embodiment described here, the driver seat, such as the headrest of the driver seat, is adjusted in a predetermined seat adjustment within a known adjustment field. In this case, the spatial coordinates of the driver seat, such as the headrest of the driver seat, are known in the predetermined seat adjustment.

The predetermined seat adjustment may be known, for example, from a memorized user profile. The user profile can be automatically retrieved, such as before the driver of the vehicle takes his place, and being dependent on respective authentication with which the driver authenticates himself.

In some embodiments, the spatial coordinates of the eye point may be estimated or approximated with the aid of the spatial coordinates of the driver seat, such as with the aid of the spatial coordinates of the headrest of the driver seat.

Alternatively or additionally, the spatial coordinates of the eye point may be determined by an interior camera of the motor vehicle and/or by ultra-wide-band (UWB) sensors. In particular, an x-coordinate of the eye point, i.e., a coordinate along the vehicle longitudinal direction, may be determined with the aid of a current position of the driver seat in the seat adjustment field. A z-coordinate, i.e., a coordinate along the vehicle vertical axis, may be determined, for example, through the interior camera. A y-coordinate, i.e., a coordinate along the vehicle transverse axis, can be surmised or assumed to be the center axis of the driver seat. Alternatively or additionally, the y-spatial coordinate may likewise be determined through the interior camera.

Alternatively or additionally, the position of the eye point may also be determined in relation to known components in the interior of the motor vehicle. The known components can be, as described above, a handle and/or the B-column and/or a driver seat in a known seat position. For this, the position of the driver seat, such as the headrest of the driver seat, may be determined in relation to the known component.

A further embodiment calls for the adjustment of the mirror surface to be corrected in an additional step of the method, and with the aid of the correction it is ascertained whether the adjustment was done correctly, and the correction is provided to a correction algorithm for the correcting of the method. In other words, the method can be constantly improved in a self-learning process with the aid of the correction so performed.

Other embodiments relate to a motor vehicle having at least one outside mirror, wherein the outside mirror comprises a mirror surface and at least one actuator, wherein the mirror surface is mounted in a housing of the outside mirror able to swivel by adjusting a respective actuator position on the actuator. The motor vehicle described herein comprises a control device which is adapted to adapt an adjustment of the mirror surface of the at least one outside mirror in automated manner to a current eye point of a driver of the motor vehicle.

The control device is adapted to coordinate a current actuator position of the actuator with a respective projection point in the interior of the motor vehicle, the projection point being described by spatial coordinates in the interior of the motor vehicle on which a known light source is projected from outside the motor vehicle and directed at the mirror surface of the outside mirror.

Furthermore, the control device is adapted to determine the current eye point of the driver of the motor vehicle and coordinate the eye point with the spatial coordinates in the interior of the motor vehicle.

Furthermore, the control device is adapted to adapt the adjustment of the mirror surface to the eye point so determined by adjusting on the actuator that actuator position which is coordinated with the projection point whose spatial coordinates correspond to the spatial coordinates of the eye point.

Some embodiments also include modifications of the motor vehicle described herein having features as were already described in connection with the modifications of the method described herein, and vice versa. For this reason, the corresponding modifications of the motor vehicle will not be described here further.

The motor vehicle described herein may be designed as an automobile, such as a passenger car or a truck, or as a personal bus or motorcycle.

For application cases or situations which may arise during the method and which are not explicitly described here, it can be provided that an error message and/or a request to enter a user feedback will be put out according to the method, and/or a standard setting and/or a predetermined initial state will be established.

Some embodiments may also include the control device for the motor vehicle. The control device can comprise a data processing device or a processor device which is adapted to carrying out embodiments of the methods described herein. For this, the processor device can comprise at least one microprocessor and/or at least one microcontroller and/or at least one FPGA (Field Programmable Gate Array) and/or at least one DSP (Digital Signal Processor). Furthermore, the processor device may comprise program code which is adapted to carrying out embodiments of the methods described herein when executed by the processor device. The program code can be stored in a data storage of the processor device. The processor circuit of the processor device can comprise, e.g., at least one circuit board and/or at least one SoC (System on Chip).

Some embodiments may also encompass a computer-readable storage medium, containing program code which, when executed by a processor circuit of a computer or a cluster of computers, causes them to carry out an embodiment of the methods described herein. The storage medium may be provided, at least partly, for example, as a nonvolatile data storage (such as a flash memory and/or as an SSD—solid state drive) and/or at least partially as a volatile data storage (such as a RAM—random access memory). The storage medium can be located in the processor circuit in its data storage. But the storage medium can also be operated, for example, as a so-called appstore server in the Internet. A processor circuit with at least one microprocessor may be provided by the computer or the computer cluster. The program code may be provided as binary code or Assembler and/or as source code of a programming language (such as C) and/or as program script (such as Python).

Embodiments of the present disclosure also encompass combinations of the features of the described embodiments. Thus, the disclosure also encompasses realizations having a combination of the features of several of the described embodiments, as long as the embodiments were not described as being mutually exclusive.

### BRIEF DESCRIPTION OF THE SEVERAL VIEWS OF THE DRAWINGS

In the following, embodiments of the present disclosure are described.

FIG. 1 is a schematic representation of a determination of an eye point of a vehicle passenger in the interior of a motor vehicle.

FIG. 2 is a schematic representation of a method for the automated adapting of an adjustment of a mirror surface of at least one outside mirror of a motor vehicle.

### DETAILED DESCRIPTION

In the following embodiments, the components which are described for the embodiments each constitute individual features, to be considered independently of each other, and which may be combined to provide yet further embodiments. Therefore, the disclosure shall also encompass other than the presented combinations of features. Moreover, the described embodiments can also be amplified with other of the already described features of the disclosure.

In the figures, the same reference numbers denote elements of identical function.

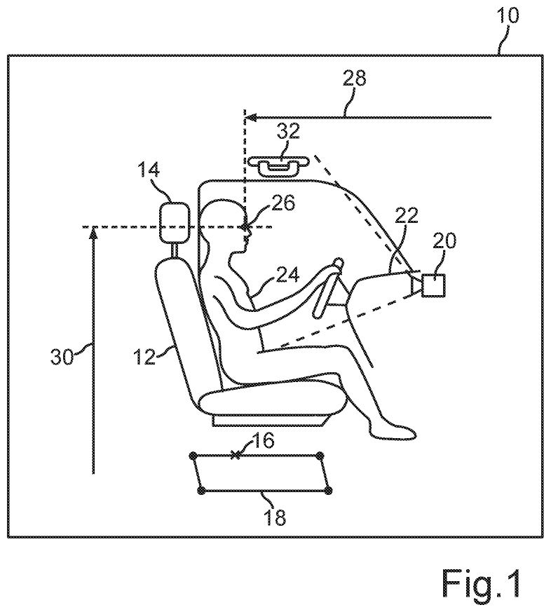

FIG. 1 shows a schematic representation of a motor vehicle 10. In the motor vehicle 10 there is arranged a vehicle seat 12 with a headrest 14. The vehicle seat 12 is adjusted in a predetermined seat adjustment 16 within a known adjustment field 18 for the vehicle seat 12.

Furthermore, the motor vehicle 10 has an interior camera 20. The interior camera 20 may be arranged in a dashboard 22 of the motor vehicle 10 and be pointed at a motor vehicle passenger 24.

In the described motor vehicle 10, a position of an eye point 26 of the passenger 24 can be determined as follows. Through the seat adjustment 16, a position of the vehicle seat 12 along a vehicle longitudinal axis or x-axis is known. The vehicle x-axis in the present case is denoted by the reference number 28. Through the known position of the driver seat 12 in relation to the x-axis 28 of the vehicle 10, a position of the headrest 14 of the driver seat 12 along the x-axis 28 can be determined approximately. It is possible to store in memory in the motor vehicle 10 how the user 24 typically takes his place on the vehicle seat 12. With the aid of this information, the spatial coordinate along the x-axis 28 of the eye point 26 can be approximated or estimated. The spatial coordinate along the vehicle vertical axis or z-axis 30 of the motor vehicle 10 can be determined with the aid of a picture of the vehicle passenger 24 taken by the interior camera 20. A spatial coordinate of the eye point 26 along a vehicle transverse axis or y-axis, not shown here, can be approximated as the center axis position of the driver seat 12. Alternatively or additionally, the position of the eye point 26 may be established in regard to a known component, such as in relation to the handle 32 in the interior of the motor vehicle.

Once the spatial coordinates of the eye point 26 are known, the adjustment of a mirror surface of an outside mirror of the motor vehicle 10, not shown here, can be adapted to the eye point 26.

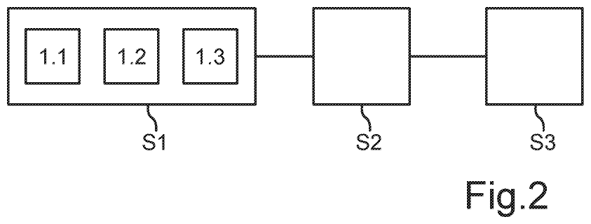

FIG. 2 shows a schematic representation of a method for the automated adapting of an adjustment of a mirror surface of at least one outside mirror of a motor vehicle 10 to a current eye point 26 of a driver 24 of the motor vehicle 10. The outside mirror comprises at least one actuator, and the mirror surface is mounted in a housing of the outside mirror and able to swivel by adjusting a current actuator position at the actuator.

According to a first step of the method, a respective actuator position of the actuator is coordinated with a respective projection point in an interior of the motor vehicle 10, the projection point being described by those spatial coordinates in the interior of the motor vehicle 10 on which is projected a known light source from outside the motor vehicle 10, being directed at the mirror surface of the outside mirror. The coordinating is done by moving the actuator in a step S1.1 from a first known actuator position to at least one further known actuator position. In a step S1.2, an image detection device or interior camera 20 in the interior of the motor vehicle 10 registers the respective current spatial coordinates of the projection point migrating with the movement of the actuator from the first to the second actuator position in the interior. In a step S1.3, the respective current spatial coordinates of the respective current actuator position are permanently assigned.

The described calibration step S1 can be performed as one of the last steps in the vehicle production. It is possible to position one or more, such as two light or laser sources at a defined position to the right and left behind the motor vehicle 10. The light source can be directed at the particular outside mirror. The reflected light signal can be alternately detected by the interior camera 20 in the motor vehicle interior. During this calibration step S1, the vehicle seat 12 can find itself in a predefined position, while the mirror surfaces of the outside mirror can be moved from one end position to the other in their tilting about the z-axis 30 and the y-axis of the vehicle 10. After the calibration described here, the vehicle's specific adjustment possibilities of the mirror relative to the vehicle interior and to a defined point in the seat adjustment field 18 are known and can be used for the automated outside mirror adjustment, described in the following.

In one step S2 of the method, the current eye point 26 of the driver 24 of the motor vehicle 10 is determined, the eye point 26 being coordinated with spatial coordinates in the interior of the motor vehicle 10.

The eye point 26 can be determined as in the context of the explanations for FIG. 1. In the event that multiple interior cameras 20 are present, the eye point 26 of the driver 24 can also be determined solely through the camera images and in relation to reference points in the motor vehicle interior. As a reference point, for example, it is possible to use the position of the handle 32. If only one interior camera 20 is installed, the current position of the driver seat 12 can additionally be determined in the seat adjustment field 18. This provides information about the x-coordinate of the eye point 26. In addition, the z-coordinate of the driver eye point 26 can be determined through the interior camera 20. The outcome of the described determination furnishes a z-coordinate and an exact or nearly exact x-coordinate of the eye point 26 (depending on the number of interior cameras 20 used). As described above, the y-coordinate of the eye point 26 can either be set equal to the center axis of the driver seat 12 as an approximation or it can likewise be detected through the interior camera 20.

In a step S3 of the method, the adjustment of the mirror surface is adapted to the eye point 26 so determined by adjusting at the actuator the actuator position which is coordinated with the projection point whose spatial coordinates correspond to the spatial coordinates of the eye point 26.

In other words, from the information obtained in steps S1 and S2 of the method it is possible to compute geometrically, and accordingly in automated manner, the optimal outside mirror adjustment. The driver 24 need do nothing further for this. However, the possibility can still exist of manually adjusting the outside mirror when necessary or by special preference of the driver 24.

In addition, previously performed adjustments can be added to drivers 24 through their profile, so that the adjustments can already be performed as soon as the driver 24 has been identified. In this way, the described adjustment process can be speeded up. Moreover, repeated adaptations of the automated adjustment can be learned and taken into account for future adjustments. This may involve preferences, for example, how much of one's own vehicle 10 should be visible in the outside mirror.

On the whole, the examples show how a method may be provided for the fully automated adjustment of an outside mirror in a motor vehicle 10.

German patent application no. 10 2022 122033.8, filed Aug. 31, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for automated adapting of an adjustment of a mirror surface of at least one outside mirror of a motor vehicle to a current eye point of a driver of the motor vehicle, wherein the outside mirror comprises at least one actuator, wherein the mirror surface is mounted in a housing of the outside mirror able to swivel by adjusting a respective actuator position on the actuator, the method comprising:
coordinating a respective actuator position of the actuator with a respective projection point in an interior of the motor vehicle, the projection point being described by spatial coordinates in the interior of the motor vehicle on which a known light source is projected from outside the motor vehicle and directed at the mirror surface of the outside mirror;
determining the current eye point of the driver of the motor vehicle, coordinating the eye point with spatial coordinates in the interior of the motor vehicle; and
adapting the adjustment of the mirror surface to the eye point so determined by adjusting at the actuator the actuator position which is coordinated with the projection point whose spatial coordinates correspond to the spatial coordinates of the eye point.

2. The method according to claim 1, wherein coordinating the respective actuator position of the actuator with the respective projection point in the interior of the motor vehicle is done by:
moving the actuator from a first known actuator position to at least one further known actuator position,
wherein an image detection device in the interior of the motor vehicle registers the respective current spatial coordinates of the projection point migrating with the movement of the actuator from the first known actuator position to the at least one further known actuator position in the interior, and
the respective current spatial coordinates are permanently assigned to the respective current actuator position.

3. The method according to claim 2, wherein a respective actuator position is described by the time elapsed since leaving the known actuator position.

4. The method according to claim 1, wherein the spatial coordinates of the projection point are determined by ascertaining the relative spatial position of the projection point in regard to a spatially unchanging component having known spatial coordinates in the interior of the motor vehicle.

5. The method according to claim 4, wherein the spatially unchanging component having known spatial coordinates in the interior of the motor vehicle is a handle of the motor vehicle.

6. The method according to claim 4, wherein the spatially unchanging component having known spatial coordinates in the interior of the motor vehicle is a B-column of the motor vehicle.

7. The method according to claim 1, wherein the spatial coordinates of the projection point are determined by ascertaining the relative spatial position of the projection point in regard to a vehicle seat of the motor vehicle.

8. The method according to claim 7, wherein the spatial coordinates of the projection point are determined by ascertaining the relative spatial position of the projection point in regard to a headrest of the vehicle seat.

9. The method according to claim 8, wherein the headrest of the vehicle seat is adjusted in a predetermined seat adjustment within a known adjustment field, and the spatial coordinates of the headrest of the vehicle seat are known in the predetermined seat adjustment.

10. The method according to claim 9, wherein the predetermined seat adjustment is known from a memorized user profile.

11. The method according to claim 10, wherein the memorized user profile is that of the driver.

12. The method according to claim 8, wherein the spatial coordinates of the eye point are estimated with the aid of the spatial coordinates of the vehicle seat.

13. The method according to claim 12, wherein the spatial coordinates of the eye point are estimated with the aid of the spatial coordinates of the headrest of the vehicle seat.

14. The method according to claim 1, wherein the spatial coordinates of the eye point are determined by an interior camera of the motor vehicle.

15. The method according to claim 1, wherein the spatial coordinates of the eye point are determined by ultra-wide-band sensors.

16. The method according to claim 1, further comprising correcting the adjustment of the mirror surface, and with the aid of the correction, ascertaining whether the adjustment was done correctly, and providing the correction to a correction algorithm for the correcting of the method.

17. A motor vehicle having at least one outside mirror, the outside mirror comprising:
a mirror surface; and
at least one actuator, wherein the mirror surface is mounted in a housing of the outside mirror able to swivel by adjusting a respective actuator position on the actuator, wherein the motor vehicle comprises a control device which is adapted to adapt an adjustment of the mirror surface of the at least one outside mirror in an automated manner to a current eye point of a driver of the motor vehicle.

18. The motor vehicle of claim 17, wherein the control device is adapted:
to coordinate a current actuator position of the actuator with a respective projection point in an interior of the motor vehicle, the projection point being described by spatial coordinates in the interior of the motor vehicle on which a known light source is projected from outside the motor vehicle and directed at the mirror surface of the outside mirror,
to determine the current eye point of the driver of the motor vehicle and coordinate the eye point with the spatial coordinates in the interior of the motor vehicle, and
to adapt the adjustment of the mirror surface to the eye point so determined by adjusting on the actuator that actuator position which is coordinated with the projection point whose spatial coordinates correspond to the spatial coordinates of the eye point.
